(19) United States
(12) Patent Application Publication
(10) Pub. No.: US 2003/0154197 A1
(43) Pub. Date: Aug. 14, 2003

(54) Flexible relational data storage method and apparatus

(75) Inventors: Ryan V. Millet, Springfield, VA (US); Andrew C. Moll, Fairfax, VA (US)

Correspondence Address: FOLEY AND LARDNER, SUITE 500, 3000 K STREET NW, WASHINGTON, DC, 20007, US

(73) Assignee: Permutta Technologies

(21) Appl. No.: 10/364,452

(22) Filed: Feb. 12, 2003

Related U.S. Application Data
(60) Provisional application No. 60/355,888, filed on Feb. 13, 2002.

(51) Int. Cl. G06F 7/00

(52) U.S. Cl. 707/9

(57) ABSTRACT

A method and apparatus for providing a flexible database application capable of permitting users to add, update or delete data columns and optionally their display attributes from a relational database management system data table is disclosed. A set of data records are stored in, four or more tables as a data compilation. A primary key used to locate specific data records and a row identifier key are stored in a data key data table. The name of the set of data records and a corresponding table identifier key are stored in a dynamic column support data table. The table identifier key is also stored along with a field identifier key and data field attributes information in a custom fields data table. The row identifier key, the field identifier key and a stored data value are stored in a separate custom value data table.

### BACKGROUND OF THE INVENTION

This application claims the benefit of priority of U.S. Provisional Application No. 60/355,888 filed Feb. 13, 2002.

The present invention relates generally to the field of computer database systems and methods, and more particularly to an improved, more-flexible database architecture which permits user-modifiable data tables.

With the coming of the information age, storing, accessing and maintaining small to medium-sized information databases has become integral to the economy. Several database management software programs have been developed and are implemented in innumerable database applications. Creating, maintaining and enhancing such databases is a large expense for many government and business organizations.

With the advent of the World Wide Web, information databases are increasingly accessed by users over the Internet. Typically, users access such databases by establishing an Internet connection to the server computer on which the database system runs (the database host server computer) by sending data requests via the Internet from a web browser running on the user's computer. The web server accepts the user's request for data and transmits it as a data query via a TCP/IP protocol over the Internet to the database host server computer. A database management system utilizes the user's query to locate the requested data, and provide the data to the server computer. The server computer formats the data into a hypertext markup language (e.g., “HTML”) document which is transmitted over the Internet back to the user's computer. The web browser running on the user's computer then displays the HTML document on the computer screen as if the display page had been stored in the database. Such user-friendly access to data services have led to the wide spread implementation of customer-accessible databases in a variety of government and business applications.

Typical information databases accessed via the Internet employ relational database management system (RDBMS) software to store, maintain and provide access to specific records of information. An RDBMS is a system that organizes data stored on computer-readable media according to a system of rules and structures. RDBMS databases require that each item of data be classified according to a particular “relation” which allows the software to readily find each datum. Typically, RDBMS systems store information in “tables,” where each “row” in the table represents a particular group of related data, known as a “record,” and where each “column,” in the table represents the type, or attributes of the data stored in that column. Data records comprise a number of data “fields” or columns which must comply with the data format or constraints determined for the associated column.

The field constraint information defined in the attributes of individual columns in a data table is used by the web server computer to format the information into an HTML document by attaching HTML “tags” to each piece of data. Thus, the structure defined for an RDBMS database table facilitates communicating data via the Internet to users in a user friendly format (i.e., a web page format).

The value of the Internet as a medium for accessing and maintaining information cannot be understated. The Internet provides unprecedented real-time access to business data to any authorized user from anywhere on any computer as long as Internet connectivity is present.

Applications delivering information as HTML documents via the Internet to the web browser running on the user's computer eliminates the need for custom software solutions to be installed on each user's computer. This greatly reduces the complication and time required to implement, field and troubleshoot software on user machines. Consequently, the Internet is being used by businesses to provide direct access to business information to traditionally indirect users of such information, including customers, vendors, dealers, and service providers. Providing access to such third-party information users has increased the number of parties involved in data maintenance activities.

The structural limitations imposed by RDBMS and web server software that facilitate the generation of HTML documents for the exchange of information over the Internet, also limit the flexibility of implementing applications. Typically, any change to the structure of a database, such as to add an additional “column” of information (i.e. adding a field to data records), requires significant reprogramming of the application software by the systems integrator or applications vendor. The expense and time required to modify RDBMS database tables limits their use to situations where the database structure does not change frequently (i.e., the number of columns in data tables remain “static”).

Since many database implementations involve evolving user requirements driving changes to data table structures, a need exists for a more flexible method for storing and retrieving data accessible via Internet protocol.

### SUMMARY OF THE INVENTION

According to an embodiment of the present invention, a computer-readable medium is disclosed having stored thereon a computer-readable program code comprising a sequence of instructions which, when executed by a computer, cause the computer to perform steps of receiving from a user computer a query to display a data record within a set of data records having a name, with the query including a primary key uniquely associated with the data record, using the name of the set of data records to retrieve a table identifier key from a data table of table identifier keys associated with one or more sets of data records, using the primary key to access from a data record table a row identifier key, using the table identifier key to access one or more field identifier keys for the set of data records from a table of data field attributes information, sending to the user computer the data field attributes information for each data field identifier key, sending to the user computer the content of each data field uniquely associated with each data field identifier key and the row identifier key, and sending to the user computer the content of a separate data field associated with the row identifier key if a data field identifier key indicates a separate data field is associated with the row identifier key.

According to another embodiment of the present invention, a method for deleting a data field or column from a set of data records having a name and a custom fields table for storing data field attribute information, wherein the column is identified by a column identifier key, is disclosed comprising the steps of receiving from a user computer the name of the set of data records, the column identifier key and a request to delete the column identified by the column identifier key, using the column identifier key to indicate the associated column as inactive in the custom fields data table, and sending to the user computer a message acknowledging that the data field or column has been deleted.

In a further embodiment of the invention, a method of adding data fields or columns for storage of data in a set of data records having a name that is a table identifier key in a relational database is disclosed comprising the steps of receiving from a user computer a request to create a new data field or column in a table and the tables identifier key, using the table identifier key to retrieve a list of columns and a list of attributes from a custom fields data table associated with the table identifier key, sending to the user computer the list of columns and the list of attributes, using an interface software program, like a web-browser based form, to collect the data field attributes information from the user for the new data field or column, receiving from the user computer the data field attributes information, and storing the data field attributes information in the custom fields data table, and sending to the user computer the an acknowledgement message confirming that the data field or column has been added.

According to another embodiment of the present invention, a method for providing access to data in the form of a set of data records having a name stored within in relational database system is disclosed which comprises the steps of receiving from a user computer a query to display a data record (e.g., a request to view or to update the data record) within the set of data records, the query comprising a primary key uniquely associated with the data record and the name of the set of data records, using the name of the set of data records to retrieve a table identifier key from a data table of table identifier keys associated with sets of data records, using the primary key to access from a data record table a row identifier key, using the table identifier key to access field identifier keys for the set of data records from a table of data field attributes information, sending to the user computer the data field attributes information for each data field identifier key, and sending to the user computer the content of each data field uniquely associated with each data field identifier key and the row identifier key, including large or special data (e.g., text or images) from data fields that may be stored in a separate data table when the which such data is indicated by a data field identifier key or other record associated with the row identifier key. In a further embodiment of the invention, additional steps may include receiving new or modified data for the displayed data record, storing the new or modified data in the data field uniquely associated with each data field identifier key and the row identifier key.

According to yet another embodiment of the present invention, a computer system is disclosed for storing a set of data records comprises a central processor, an Internet access port connected to the central processor and to a network, and a data storage system connected to the central processor, wherein the data storage system has stored thereon a sequence of instructions executable by the central processor which, when executed by the central processor, causes the central processor to perform the steps of receiving from a user computer a query to display a data record within the set of data records, the query comprising a primary key uniquely associated with the data record and the name of the set of set of data records, using the name of the set of data records to retrieve a table identifier key from a data table of table identifier keys associated with sets of data records, using the primary key to access from a data record table a row identifier key, using the table identifier key to access field identifier keys for the set of data records from a table of data field attributes information, sending to the user computer the data field attributes information for each data field identifier key, and sending to the user computer the content of each data field uniquely associated with each data field identifier key and the row identifier key.

In yet another embodiment of the present invention, a method for programming computer-implemented data application in a relational database including a set of data records having a name, comprising the steps of creating a data key data table comprising a primary key and a row identifier key for uniquely identifying a data record for the primary key and row identifier key, creating a column support data table comprising a table identifier key and the name of the set of data records, creating a custom fields data table comprising the table identifier key, a field identifier key, and data field attributes information for non-key data each related to a row identifier key, and creating a custom value data table comprising the field identifier key, the row identifier key, and stored data uniquely related to the field identifier key and the row identifier key.

### BRIEF DESCRIPTION OF THE DRAWINGS

FIG. 1 is an illustration of a data screen for projection on a users computer screen.

FIG. 2 is an exemplary data table associated with the data screen shown in FIG. 1.

FIG. 3 is an exemplary data table showing the field attributes of the table shown in FIG. 2.

FIG. 4 is a flow chart of actions to create a database application employing conventional data structures.

FIG. 5 is an exemplary key data table according to an embodiment of the present invention.

FIG. 6 is an exemplary data table showing the field attributes of the table shown in FIG. 5.

FIG. 7 is an exemplary Custom Field Tables data table.

FIG. 8 is an alternative version of the exemplary data table shown in FIG. 7.

FIG. 9 is an example of the table specification for the tables shown in FIGS. 7 and 8.

FIG. 10 is an example Custom Fields data table.

FIG. 11 is an alternative view of the Custom Fields data table.

FIG. 12 is an example of the table specification for the tables shown in FIGS. 10 and 11.

FIG. 13 is an example Custom Field Values data table.

FIG. 14 is an alternative view of the Custom Field Values data table.

FIG. 15 is an example of the table specification for the tables shown in FIGS. 13 and 14.

FIG. 16 is a flow chart of a process for setting up a database application.

FIG. 17 is a flow chart of a process for creating a database application including user-creation of data columns.

FIG. 18 is a flow chart of a process implemented for creating, updating or deleting data columns.

FIG. 19 is a flow chart of a process for creating a new data column.

FIG. 20 is a flow chart of a process for updating an existing data column.

FIG. 21 is a flow chart of a process for deleting an existing data column.

FIG. 22 is a flow chart of a process for accessing a data record.

FIG. 23 is a diagram of a computer system suitable for implementing an embodiment of the present invention.

### DETAILED DESCRIPTION OF THE INVENTION

The present invention discloses methods and apparatus for storing, manipulating and retrieving data in a dynamic data structure implemented on a standard RDBMS. By storing a set of data records traditionally represented in a flat RDBMS data table in a linked series of data tables, this invention provides a method for developing database applications which permit the user to change the structure of the data records without requiring modifications to the application software or the associated data table structures implemented in the RDBMS.

Data is stored in a computer memory implementing an RDBMS in the form of tables comprising columns and rows. Each row represents an individual record of data that are necessarily related. Each data record comprises a number of fields of individual data, where each datum may be a different kind of information, such as numerical, alpha numeric, Boolean, date, image, memory location pointer, etc. The database table is organized into columns of similar types of data, so as to represent the name of each field of information within a data record. A particular datum in an RDBMS may be found by specifying the particular row and particular column that uniquely identifies that datum.

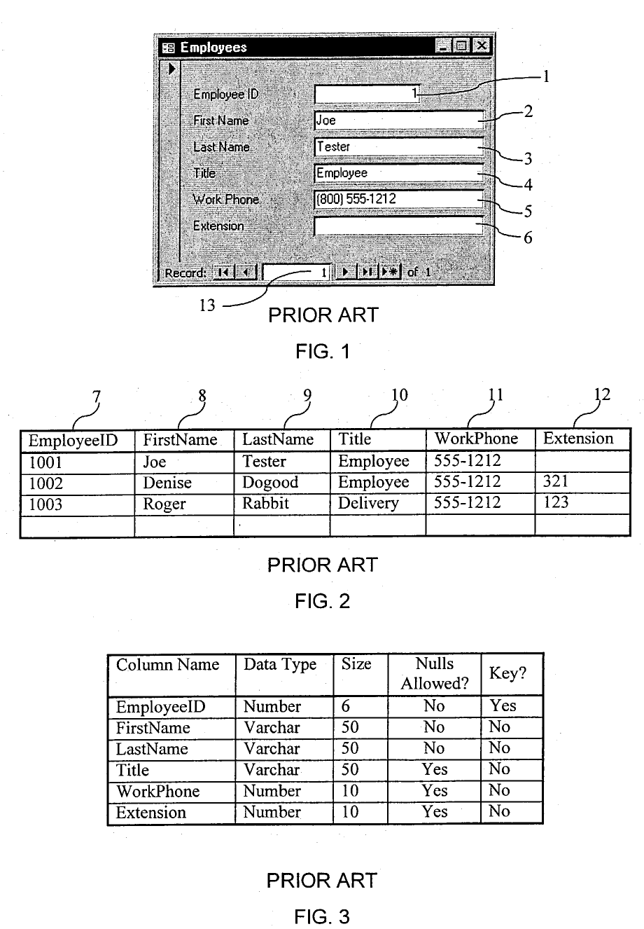

Typically, a particular record of information (i.e., a data record) may be displayed on the user computer in the form of an HTML document, for example, often called a “screen,” such as the example shown in FIG. 1. Note that the invention is not limited to the HTML protocol, but may use any convenient protocol. The data record will have a unique identifier, such as the Employee ID 1, which is unique to that particular data record. As shown in FIG. 1, such a data record will generally include other fields of information, such as, for example, the employee's first name 2, last name 3, job title 4, phone number 5, and extension 6. A single data record would contain each of these fields of information. This data screen also shows that each field of information has associated with it a name of that field which corresponds to the column heading in the data table containing the data record. For example, the data table FIG. 2 which stores the data displayed in the screen in FIG. 1 contains columns entitled “EmployeeID” 7, “FirstName” 8, “LastName” 9, “Title” 10, “WorkPhone” 11, and “Extension” 12. FIG. 1 also shows that the data table may identify a data record by its ordinal number 13.

The simple example screen shown in FIG. 1 displays six data fields (1-6). These data fields would be maintained in an RDBMS database comprising six “columns” of data, with each row in the table containing the fields of data comprising the data record shown in the screen.

An example of a database table that would correspond to FIG. 1 is shown in FIG. 2. In this example, selected employee information has been stored for three employees. Each row of the table in FIG. 2 represents a single data record uniquely identified by the field “EmployeeID” 7. The “EmployeeID” 7 field is known as a “primary key” because it provides a unique identifier for a particular data record. An example of a typical primary key used in databases related to personal information is the Social Security Number.

Information is stored in an RDBMS data table according to the types of information expected. Thus, each field in a data table is constrained to a particular size and type of data referred to generally herein as the data “attributes” .When setting up a database table, these constraints or attributes are defined for each column. FIG. 3 shows the attributes of each of the columns of the example data table shown in FIG. 2. As shown in FIG. 3, the column entitled “EmployeeID” is limited to numeric data six digits in length for which there must be data (i.e., nulls are not allowed). Further, in the attributes of the column entitled “EmployeeID” requires that each datum be a key, i.e., the information is used to locate individual data records. Similarly, the second column, entitled “FirstName,” is limited to character data 50 characters in length which must be present in the record. The characteristics shown in FIG. 3 are referred to as the data field attributes. A database application uses the data attributes to properly display each data field on the computer screen. Thus, a computer must know which type of data to expect and how large a field to provide for on the screen in order to properly display each data field. Similarly, an application storing a data record must know when all of the necessary fields of information have been provided, indicated by the attribute that nulls are or are not allowed in particular data fields.

As mentioned above, data records within a database may be identified by what are known as “keys.” A “primary key” is a unique identifier for a particular record. “Secondary keys” are keys which may be used to find the record or find aspects of a record or related records, either in combination or without consideration of the primary key. “Foreign keys” are unique identifiers to information found in other data tables. For example, a database table of employee information could contain a “primary key”, such as each employee's social security number, one or more secondary keys, such as the employee's last name and first name, and foreign keys, such as the employee's telephone number, which would correspond to a primary key in a telephone database table. Thus, a database query using the employee's social security number could identify the individual by name and his or her telephone number which could then be used to access a database of telephone-specific information to find data records associated with that individual's telephone, such as, for example, billing information or telephone numbers dialed from that number.

Traditionally, the attribute information displayed in FIG. 3 is built into the data table when it is first set up by the application provider. In other words, the data field is set up so that it can only accept information in each field that matches the characteristics or attributes associated with the corresponding column in the data table. Databases constructed in this manner present difficulty for users when there is a need to add or change a data field in the data table. For example, if the user decided to add a new field of information to each employee record, e.g., a data field identifying an emergency contact phone number, the user would have to hire an applications provider to modify the data table. To add this new data field to the data table, the applications provider would, for example, have to add a new column for a number field of ten digits in length, and change the data display screen to add an additional field of information that would accept and display information of the proper format. While modern software development tools have made this task relatively simple, accomplishing the change requires someone who is familiar with both the RDBMS and web server software tools. There also may be a need to modify related data tables, and recompile and re-release the software, further adding to the delay, expense and complications associated with the simple addition of a single data field to the data records.

In one embodiment of this invention, the flexibility of the database application is increased by disaggregating the information usually stored within a single database table into a series of three or more database tables. First, primary key information is stored in a data table that contains only primary keys and row identification information. Second, field attribute information is stored in a separate “Custom Field Data” table as elements of information in a data record, rather than as specific field constraints established in the columns of the data table itself. Third, individual fields of information are stored in a “Custom Field Values” data table which is uniquely identified by the combination of a “Field ID” and a “Row ID”. In applications where there is more than one database table residing within the RDBMS, which would be typical, a fourth table is used to associate individual table ID's with the name of the associated data table.

The database constructed in the manner of this embodiment permits an Internet-accessible server computer to retrieve information from the RDBMS host regarding the attributes of each field of information in the database from one data table, and retrieve the individual fields of information according to those attributes from a second data table. This database structure permits the software which generates the database display screen document (for example, an HTML page) to be separated from the structure of the database itself. More specifically, the screen generating routine software retrieves information regarding the structure of the database, permitting it to allocate sufficient data windows and data field names to match the contents of the database, and then, using that structure information, retrieves the individual items of data associated with each field window. A database structured in this manner permits software that will allow a a user to change the data table structure without requiring any changes to the application software which displays the data for a user on a computer screen.

Since the attributes of the database are essentially stored in the “Custom Field” data table, new fields can be added to or removed from data records, which would traditionally requires adding or deleting “columns” in a data table, as easily as a new record can be added to or removed from any RDBMS data table. Thus, the actions of adding, modifying or deleting “columns” of data in a data table in this embodiment are equivalent to adding, editing or deleting records of data in a typical RDBMS data table. Consequently, this data organization method permits the application provider to turn over the creation, maintenance and modification of the data structure to the application user.

This embodiment of the invention is particularly well suited to database applications involving access, use, and maintenance via the internet. While breaking the information into three or four data tables may increase the data access time of the RDBMS computer, the increase in access time is a small fraction of the delay associated with Internet access and communication. Additionally, indexing of the key data fields, typically the primary and secondary keys, permits the RDBMS server to rapidly access the requested information, thus rendering any additional data access time imperceptible to the user. Further, this embodiment is particularly useful in applications where relatively few numbers of individual data records are accessed at a time.

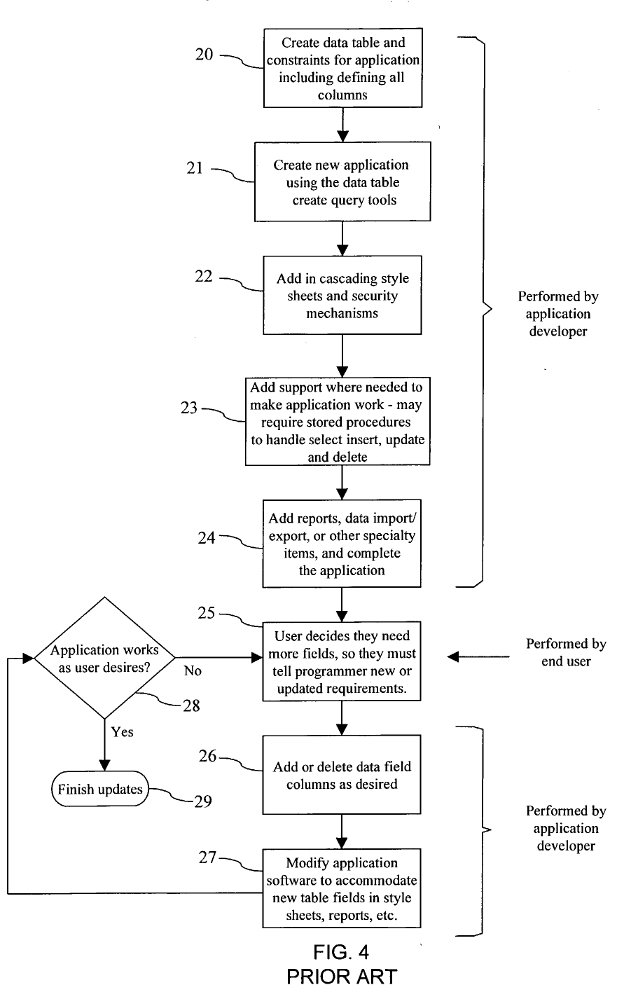

The limitations of the traditional method for storing data in tables can be understood by reference to FIG. 4. In a typical database creation effort, the programmer first creates the tables according to a set of attributes which establish constraints for each column that are then implemented into the software application, step 20. Thus, at the very beginning of the creation of a database application, all column attributes must be defined before the application coding begins. With the tables established, the programmer then creates the new application using application and database software development tools, step 21. The programmer then completes the application by writing style sheets and security mechanisms, step 22, writing procedures to handle selecting, inserting, updating and deleting data, step 23, and writing, routines to generate reports, import and export data, and provide other specialty user services, step 24. The software is then put into use by the user, at which point, inevitably, the user discovers a need to add additional columns because more fields of information must be stored with each record, step 25. This results in new application requirements and requests for changes to the programmer, step 25. The programmer then adds the requested fields to the table, step 26, and updates the application software to accommodate the new table fields in style sheets, reports and other data handling aspects of the software, step 27. Again, the application is turned over to the user for evaluation, step 28. The user then decides whether to declare the application finished, step 29, or to add more fields, which starts the reformatting and rewriting cycle all over again, step 25. Even when the user knows all data fields required in an application at the start, many uses of electronic databases defy a static data structure. When such databases need changes, the user must engage the programmer again in the cycle of adding fields to the table and revising the application software to accommodate the new table columns.

For purposes of clarity, a set of data records, that would traditionally be stored in a single data table in a conventional DBMS implementation, is referred to herein as a “data compilation” when implemented according to an embodiment of this invention as a number of interrelated data tables. Thus, a data compilation refers to a set of data records.

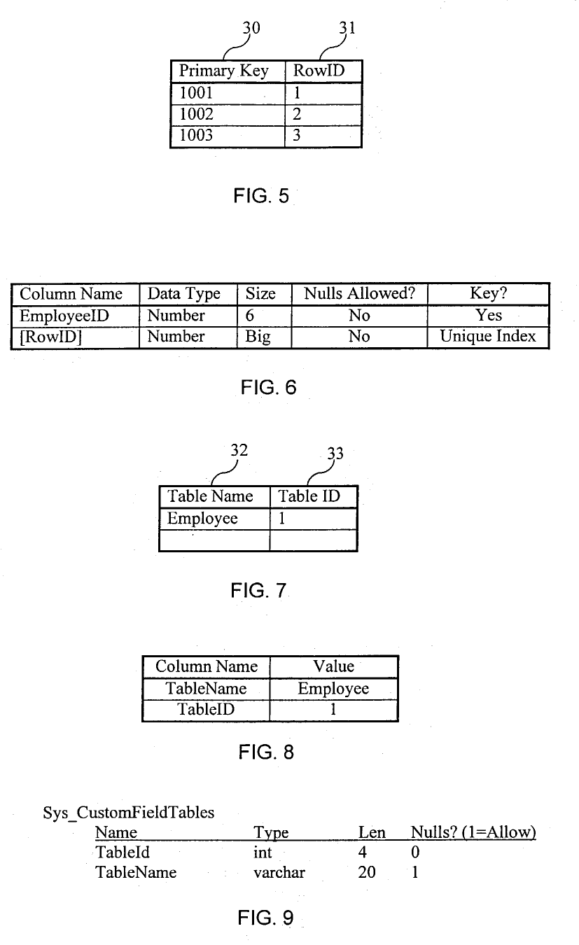

An embodiment of this invention may be better understood by reference to FIGS. 5-14. In a first step of constructing a database according to an embodiment of the invention, the primary or foreign keys of the data compilation are separated into a separate data table where they are stored along with unique row identifiers, as shown in FIG. 5. This table stores only the primary and foreign keys for a particular data compilation, such as the example data compilation entitled “Employees.” This key table stores the same primary key 30 as in a conventional database such as the data table shown in FIG. 2. However, the key table does not contain the non-key columns, which are maintained in a separate, “system level” table. If the RDBMS software does not support a unique identifier for each row, such as the virtual ROWID column in Oracle databases, then a “Row ID” 31 column must be added to the table with a unique index put in it. The primary key cannot be used for the “Row ID” because the primary key may be multi-columned. The structure and attributes of this example key table are shown in FIG. 6.

In applications where multiple data compilations may be maintained in the same RDBMS, a “Custom Field Tables” data table is included which correlates a table identification number, “Table ID” 33, with each particular data compilation which has a name, e.g., “Table Name ” 32, as shown in FIG. 7. This table is used when serving a query of a particular user input screen to identify the data tables associated with that screen. The structure of the “Custom Field Tables” data table is shown in FIG. 8. In this table, the “Table ID” field is a foreign key that is used in the “Custom Field” table. An example of the table specification used to create a “Custom Field Tables” data table is illustrated in FIG. 9.

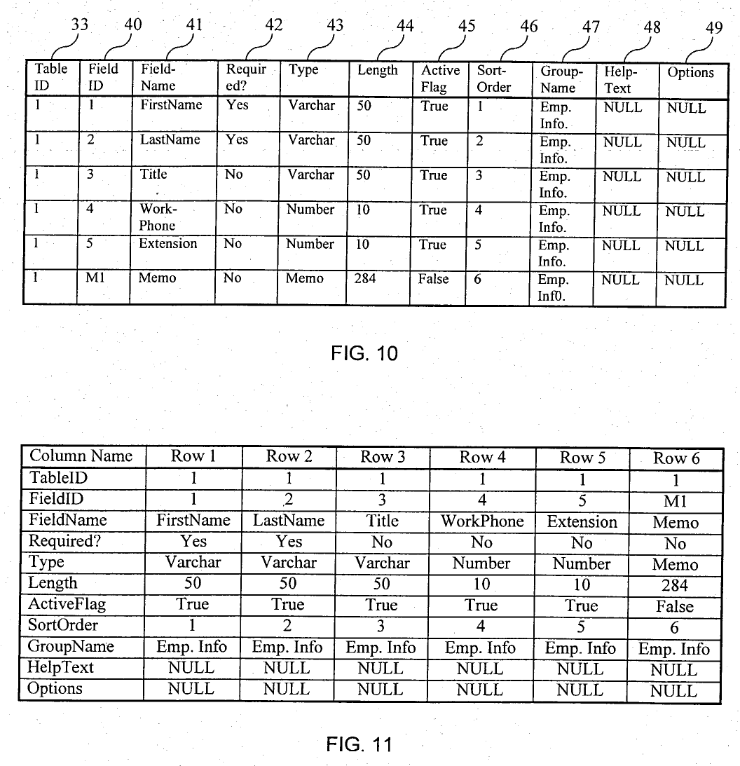

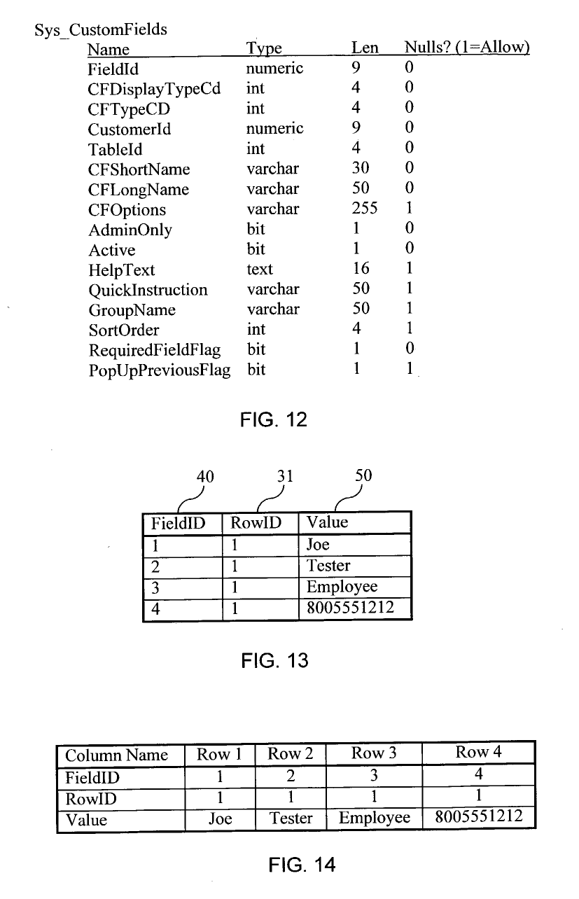

The attributes of each non-key field in a particular data compilation are stored in a “Custom Fields” table as items of data. As shown in FIG. 10, within a particular data compilation, identified by a “Table ID” 33, the non-key fields, identified by a “Field ID” 40, are described by the contents of a variety of data fields 41-49. Such attribute information may include the field name 41, whether that field is required 42 (i.e., whether nulls are permitted), the type of data in the field 43, the length of the field 44, whether or not a flag is provided 45, the sort order of the field 46, and other information, such as a group name 47, text associated with that field 48, and options 49. The same data field is shown in a different orientation in FIG. 11. As can be seen from FIGS. 10 and 11, the “Custom Fields” data table provides all of the information that the application software needs to structure a screen to display data from the data compilation, including the data type and size for each data window that is to be displayed. Further, this data table can be used to put in controls and constraints used by the application software to control the display and editing of individual data fields. For example, user access information can be included for each data “Field ID” 40 to indicate whether all users or only some users are able to view and/or edit the particular field of information. As another example, the “required ?” field 42 shown in FIGS. 10 and 11 indicates whether the data must be present in order to save a particular data record. An example of the table specification used to create a “Custom Fields” data table is illustrated in FIG. 12.

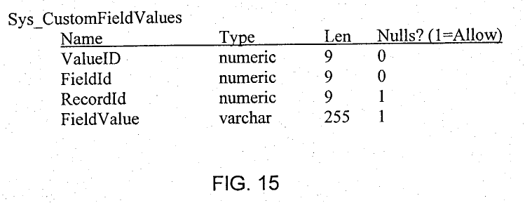

With the data structure recorded in the “Custom Fields” data table, the data itself can be saved in a separate “systems level” data table, such as the “Custom Field Values” table shown in FIG. 13. This data table stores only the data fields that are full (i.e., not null fields) in a data table that correlates a “Field ID” 40 and a “Row ID” 31 to each individual field of data 50. The “Field ID” 40 is a foreign key retrieved from the “Custom Fields” data table (FIG. 9) and the “Row ID” 31 is a foreign key retrieved from the keys data table, FIG. 5. Another orientation of the “Custom Field Values” data table is provided in FIG. 14. An example of the table specification used to create a “Custom Field Values” data table is illustrated in FIG. 15.

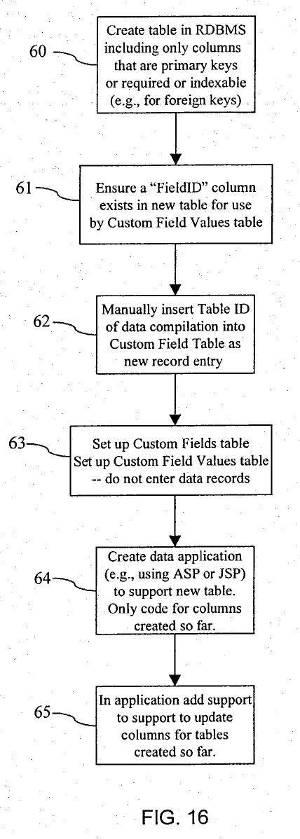

The present invention may be further understood by reference to FIG. 16, which illustrates the steps employed by an application programmer in setting up a new database application according to the present invention. The new database application, or data compilation, will be given a unique name or “Table ID” to identify the data compilation among a number of data tables or data compilations that may be stored on the data server which keeps track of the various data compilations in a “Custom Field Tables” data table. In step 60, a key data table is created using a RDBMS software application. This data table includes only columns that contain primary keys or required or secondary keys which may be foreign keys used in other database tables. The programmer must make certain that a “Field ID” column exists in the data table, such as by using the ROWID of an Oracle database, or providing a “Row ID” unique identifier as a separate column in the data table. This is because the “Field ID” is used in the “Custom Field” values data table as a foreign key, step 61.

The “Table ID” associated with this new data compilation is added to the “Custom Field Tables” data table as a new record entry in step 62.

The application programmer then creates the Custom Fields table and the Custom Field Values table in step 64. However, in doing so, the programmer need not include data in the records in these tables. A web-based application is then created using available development tools, such as, for example, Active Server Pages (ASP), JAVA Server Pages (JSP), or web cartridges (Oracle), to support the new data compilation in steps 64 and 65.

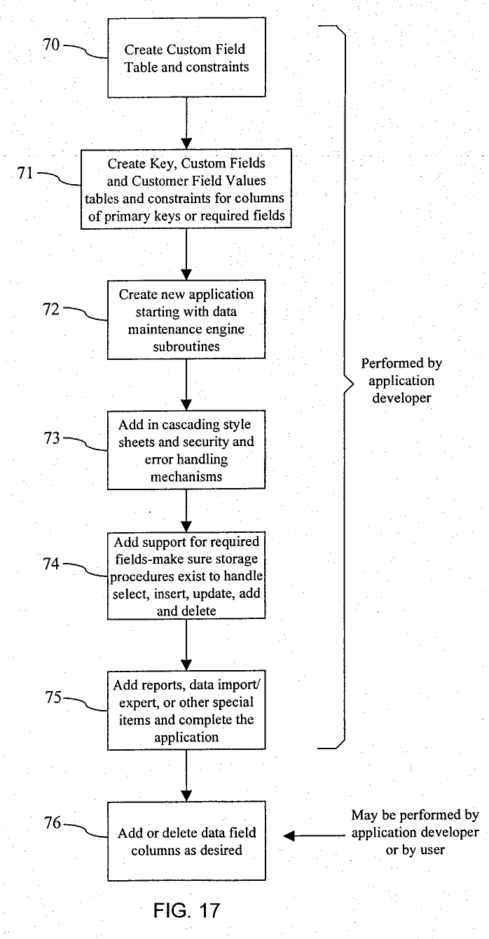

FIG. 17 shows the work flow between the programmer and the user associated with creating and managing a data compilation according to the present invention. First, the programmer creates a “Custom Field Tables” data table including the table constraints, step 70. Next, the programmer creates the “Key,” “Custom Fields,” and “Custom Field Values” data tables in step 71. The programmer then moves on to creating the new application software starting with data maintenance engine subroutines in step 72. The programmer then writes routines for cascading style sheets, security mechanisms, step 73, procedures for selecting, inserting, updating and deleting data from data fields, step 74, and routines for generating reports, importing and exporting data, and other specialty routines, step 75. At this point, the application and data compilation are turned over to the user who adds data fields to data records by adding columns as desired, step 76. The user continues to add data columns as necessary and deletes data columns if required without turning to the programmer for support.

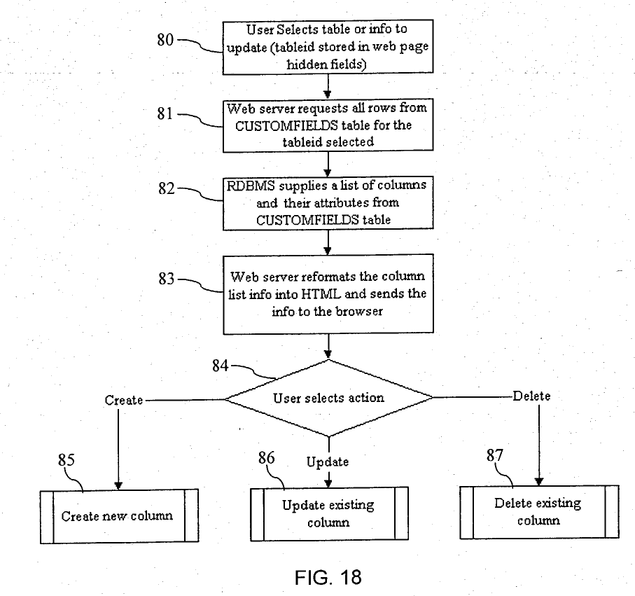

With the basic database application set up and the skeleton of the data compilation data tables created in the form of the basic four data tables described above, the user then can use the system to complete the data compilation application creation process by requesting the system to add and/or delete data columns. The data column creation and maintenance process is illustrated in FIG. 18, which is described in the following set of examples. For convenience of explanation, these examples assume that data transmission between user and web server computers is via the Internet using HTML, however, the invention is not limited to any single form of inter-computer communications network, protocol or software application. As a first step in this example, using a web browser, the user sends a request to select the set of data, or data compilation, to be updated, such as the “Employee” data compilation, and the indication of the user's selection is received by the database server computer via Internet protocol in step 80. The database server computer uses the data compilation name received from the user to look up the “Table ID” stored in the “Custom Field Tables” data table. Alternatively, the application may store the “Table ID ” within the data application editing web page in hidden fields within the selection hyperlink, in which case the database server computer receives the “Table ID” in the request received from the user.

The web server, receiving the request from the user, uses the “Table ID” to retrieve all rows from the “Custom Fields” data table associated with the selected “Table ID”, step 81. The RDBMS receives the request from the web server and supplies it with a list of the columns and the attributes stored in the “Custom Fields” data table, step 82. Using this information, the web server formats the data field list information for transmission, such as into an HTML document for example, and sends this document information to the user's web browser, step 83.

The HTML document sent to the user's computer for display on the user's computer display screen gives the user the choices of, for example, “creating,” “updating,” or “deleting” data fields within the data compilation, step 84. If in this example the user selects “creating,” the HTML document sent to the user's computer provides the user with the option to create a new data field by supplying the attribute information that is required to be stored in the “Custom Fields” data table, step 85. Examples of the type of information that the web server computer may request of the user to create a new data field column can be seen by reference to FIG. 10 in columns 41-49.

If in this example the user selects “updating,” the HTML document sent to the user's computer provides the user with the option of editing one or more of the fields of information displayed in the document which describe the data field attributes of the selected data field stored in the “Custom Fields” data table, step 86, FIG. 18. For example, the user may change the sort order for the various data fields to prompt the data server to display or sort the data in a different order. As another example, the HTML document sent to the user's computer could permit the user to change the length of the data field reserved for a particular field of data, or change whether that field of data is required.

If in this example the user selects “deleting,” the HTML document sent to the user's computer provides the user with the option of deleting an existing data field from the data compilation, step 87, FIG. 18. For example, referring to FIG. 10, the user could choose an option that would direct the web server to delete the data field with the field name “Extension” associated with “Field ID 5.”

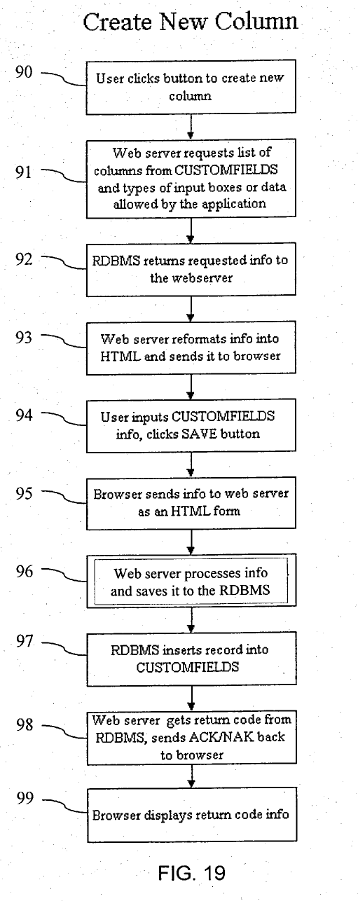

If in this example the user selects from the HTML document sent to the user's computer the “creating” option for creating new data fields (which is equivalent to creating new data columns in a traditional database application and therefore is described herein as adding a data field column), the procedures illustrated in FIG. 19 are implemented by the web server and the data system. When in this example the user clicks the hyperlink button to create a new data field, step 90, the web server receives a message via the Internet. In response, the web server requests from the RDBMS a list of the data fields stored in the “Custom Fields” data table (for example, see FIG. 10), including the types of input boxes or data allowed by the application software, step 91. The RDBMS returns the requested information to the web server in step 92. Using this information, the web server formats the information for transmission, such as into an HTML document for example, and sends that document to the user's web browser via the Internet in step 93. The HTML document sent by the web server permits the user to input information for the “Custom Fields” data table into the data windows provided in the HTML document screen and then inform the web server that information should be saved by clicking the “save” button, step 94. This sends the information via the Internet to the web server as an HTML format document, step 95. The web server processes this information, such as an ASP script for example, and sends the data field attribute information to the RDBMS in step 96. The RDBMS then receives the information and inserts it into the appropriate fields of the “Custom Fields” data table in step 97. The web server then receives and sends on to the user an acknowledgment, step 98, which is displayed for the user as return code information, step 99.

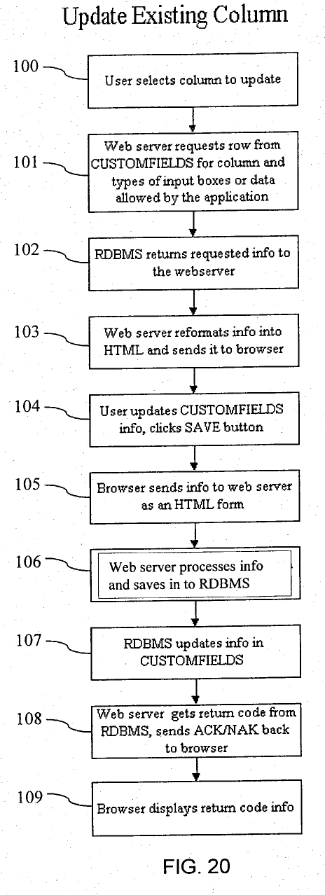

If in this example the user selects the “updating” option provided in the HTML document, the steps illustrated in FIG. 20 are implemented. When the user clicks the hyperlink button associated with updating data fields (which is equivalent to updating data columns in a traditional database application), step 100, the HTML document causes the user's web browser to send a request to the web server via the Internet. The web server receives the “updating” request message, and requests the data fields and types of input boxes or data allowed by the application from the “Custom Fields” data table (see FIG. 10, for example), step 101. The RDBMS returns the requested information to the web server in step 102. The web server reformats this information for transmission, such as into an HTML document for example, which is sent via the Internet to the user's browser in step 103. Working on the HTML document screen produced on the user's computer by the browser, the user is permitted to update the Custom Fields information and direct that the information be saved by clicking the “save” hyperlink button in step 104. The user's browser sends the information to the web server, such as via the Internet as an HTML document for example, step 105. The web server receives the information (e.g., a HTML document) transmitted from the user's computer, processes the information (e.g., HTML document) and sends the pertinent information to the RDBMS, step 106. The RDBMS uses the pertinent information to update the information stored in the “Custom Fields” data table in step 107. The web server then receives an acknowledgment code from the RDBMS which it uses to send an acknowledgment to the user's browser, step 108, which may result in a return acknowledgment code that can be displayed on the user's browser in step 109.

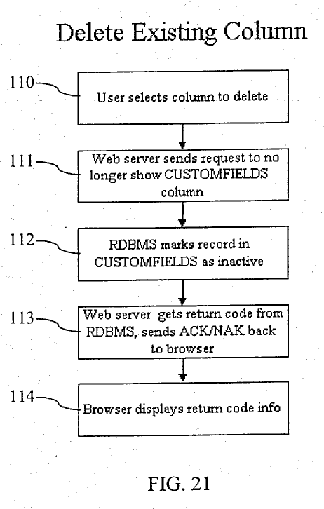

If in this example the user selects the “deleting” option provided by the web server, such as clicking on a selection shown in the HTML document for example, the procedures illustrated in FIG. 21 are implemented. When the user clicks on a hyperlink button indicating an decision to delete a data field (which is equivalent to deleting a data column in a traditional database application), the HTML document causes the user's browser (or user-interface application) to send the request to the web server, such as via the Internet for example, and the web server receives the “deleting” request message in step 110. In response, the web server sends a request to the RDBMS to no longer show the particular column in step 111. The RDBMS then marks the record (e.g., by setting a flag or storing a Boolean value) in the “Custom Fields” data table that corresponds to the “deleted” column to indicate it is inactive in step 112. The RDBMS sends a return code to the web server, which in turn sends an acknowledgment to the user's computer, step 113, which may result in an acknowledgment code that can be displayed on the user's browser in step 114.

Since database users are generally familiar with the column and row structure of traditional data tables, where fields of data within data records are organized in columns with a heading indicating the type of data in those fields, an embodiment of the present invention maintains the appearance for the user of a column and row structure of the data fields within a data compilation. To a user, a database according to an embodiment of this invention looks like a traditional data table except that the user appears to have control over the creation and deletion of columns in the database. The term “dynamic column” may be used to refer a data field within the data records of a data compilation as that field will appear to the user according to an embodiment of the present invention, to distinguish from the rigid-structure data fields used by the RDBMS to store data in a particular table within the data compilation. Thus, dynamic columns refers to the data fields of a data record within a data compilation that otherwise would be represented by the columns in a traditional RDBMS data structure.

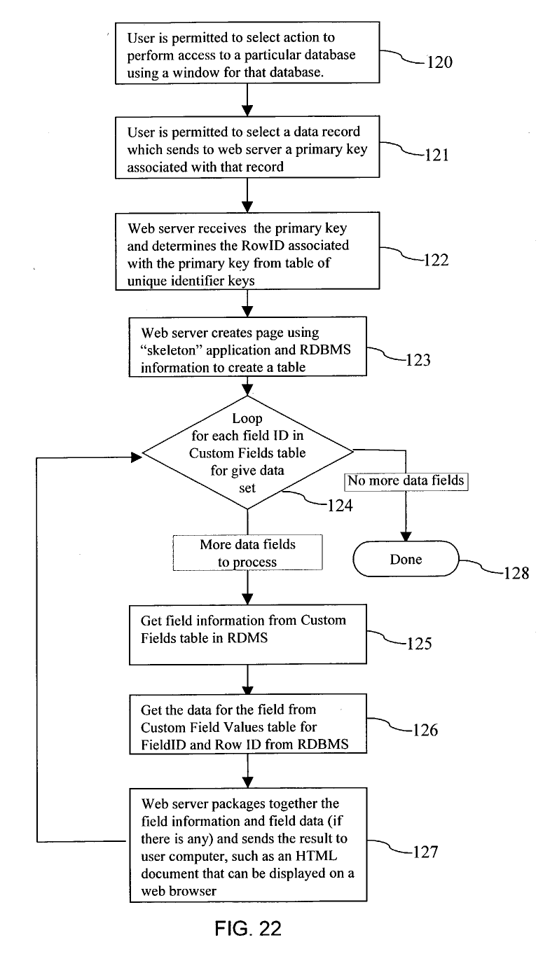

An embodiment of the present invention operates to provide users with flexible access to the data stored in the data compilation according to the steps illustrated in FIG. 22. Again in this example Internet communication protocol and HTML document structures are used for convenience of explanation, however, the invention is not limited to any single form of inter-computer communications network, protocol or software application. Also in this example, the terms “Field ID,” “Table ID,” “Custom Fields Table,” and “Custom Field Values” table are used in reference to their prior description and examples in the figures. The web server produces an HTML document that is transmitted to the user's computer where it can be displayed on the user's web browser to offer the user the choice of retrieving data from the data compilation, step 120. In this example, the user selects the option of querying data from the data compilation in step 120 by clicking on a hyperlink provided on the HTML document that appears as a data access screen on the user's web browser. In doing so, the user selects a particular record from the data table presented in the HTML document, such as by entering a search term or scrolling down a list of records within the data table. This selection may provide the “Row ID” or it may provide the primary key of the selected particular record, step 121. Operating with the hyperlinks in the HTML document, for example, the user's web browser transmits the primary key (or in some embodiments the “Row ID”) information to the web server via the Internet, step 121. The web server receives the primary key and determines the “Row ID” information, step 122. Using that information, the web server creates a skeleton page which includes background and basic screen options, step 123. In addition to background and screen options, the key values are retrieved by the web server from the RDBMS, step 123. Then, in a loop performed for each “Field ID” in the “Custom Fields Table” data table associated with the identified “Table ID,” step 124, the web server retrieves from the RDBMS the information from the “Custom Fields Table” data table, step 125, obtains the corresponding data field record from the “Custom Field Values” data table associated with each “Field ID” and “Row ID” selected, step 126, and packages the field and value information for transmission, such as into the HTML document for example, which is transmitted to the user's computer in step 127. The web server continues to perform this loop, steps 124 through 127, until there are no more data fields for the selected “Table ID,” in which case the web server indicates that the data access is complete and the data query ends, step 128. It is worth noting that an embodiment of the present invention permits the search for a selected record may be for either key or non-key fields. Once the Record ID is determined, retrieval of the remaining data can be very fast since the RDBMS indexes can be used to find the desired data fields.

Data may be inserted into data tables using an embodiment of the present invention in a manner that is similar to querying for existing data. After the user has filled in a data field displayed in an HTML document, for example, on his or her browser, the data is transmitted via the Internet to the web server. The web server receives the data for the data field and inserts the data into the normal RDBMS data table using a standard SQL “insert” statement, for example, or its equivalent for the particular database implementation. The record inserted into the data table must have some sort of unique numeric record number or key. The record number, which is the “Row ID”, is unique for all records within the data compilation, so the Row ID value field may be large. Then, for each column in the “Custom Fields Table” data table for the table being used, a new record is inserted into the “Custom Field Values” data table.

In another embodiment of the present invention, a fifth (or more) data table may be employed to store large data files or objects. If the RDBMS allows the storage of large objects, these may be stored in a separate custom field values data table that is dedicated to the storage of such large data types. For example, the program Microsoft Access permits a “memo” data field type. Since memo data might not be utilized in every data record, three large data items may be saved in a separate “Custom Field Memo Values” data table where only those memos actually present are stored. This may be implemented in an Oracle database using RAW or LONG data types in separate tables. “LONG data” fields would be retrieved either before or after all of the standard data in the “Custom Field Values” table has been retrieved. The presence of a second values table (e.g., Custom Field Memo Values table) is indicated in the Custom Fields table, as shown in FIG. 10 last record which has a Field ID 40 of “M1.”

This invention may be implemented using any RDBMS software infrastructure that permits storage of data in the form of tables comprising columns and rows. This flexibility permits development of a standard application that can be implemented across a variety of hardware and software platforms, while providing a common user interface. Such a common user interface permits both access to a data compilation, as well as modification and maintenance of the data compilation structure.

In addition to the database structure and system operation described above, a complete system may implement error handling and confirmation procedures to ensure the user does not accidentally or inadvertently add or delete columns to the database. For example, the HTML documents created by the web server could incorporate a routine to ask the user “Are You Sure?” (or similar message) before sending a data edit command or column edit command. As another example, the web server may be provided a list of users and their associated access authorization, and using the user's identity (which may be obtained in a log-in procedure) determine based on the user's authorized actions whether to implement a received command to access or edit a data record, or to change the apparent data structure. In multilevel user applications, it is expected that there weill be a need for limiting the authority to create, update or delete data columns to only certain designated users, such as the data administrator. Such procedures are well known to database software developers.

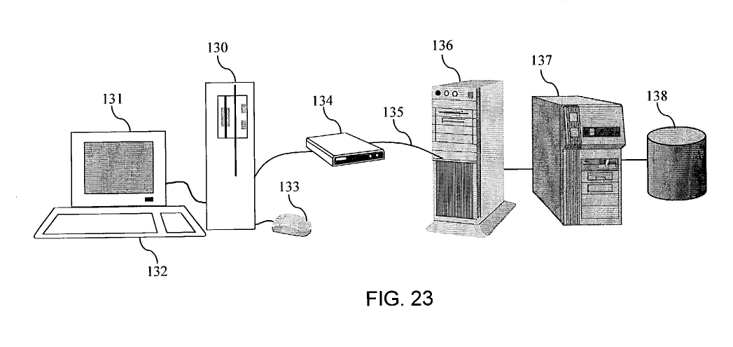

The various embodiments of the present invention may be implemented on a computer system such as that illustrated in FIG. 23. In such a system, the user could access the database from a personal computer comprising a central processing unit (CPU) 130, a display monitor 131, a user interface such as a keyboard 132 and a mouse 133. A web browser, such as Netscape or Microsoft Internet Explorer, running on the CPU 130 would provide access to the Internet such as via a modem 134 connected by telephone or high speed Internet connections 135. Information to and from the user's computer could be communicated via the Internet to a web server 136 running software implementing the present invention. The web server 136 may be any of a wide variety of commercially available general or special purpose processors, microcomputers or “server” computers. The web server 136 could access the RDBMS software running on a database computer 137 connected to a mass storage medium 138. The data storage medium 138 would be configured to operate with the database computer 137 to allow the database computer access to the digital information stored therein. Such data storage medium may include magnetic disk, compact disk (CD), magnetic tape or any other storage technology that may be developed for storing digital information. For clarity, the database computer 137 and the data storage medium 138 are illustrated as residing in separate locations. It will be apparent to one of ordinary skill in the art, however, that the data storage medium may be distributed and may reside within the database computer 137 or in another computer, and that the database computer 137 may be contained within or the functions performed by the web server computer 136.

In an embodiment of the present invention, the methods described herein are implemented on a web server or other computer in the form of a set of executable instructions or software modules which are executed by the web server in a conventional manner. Such instructions may be stored on machine readable media, and subsequently loaded into the memory of the web server for execution. Once initiated, the implementing software modules direct the web server to perform the steps of the methods described herein and in the claims.

An example of software implementing an embodiment of the present invention is attached hereto.

As will be appreciated by one of ordinary skill in the art, the present invention has numerous potential applications to real world database needs. It will be particularly useful in those applications where the number and types of data fields within data records change on a frequent basis.

One embodiment already described is for a personnel database application. Since employee-related information such as the number and types of benefit options, legal requirements, and company concerns change over time, there will often be a need to add additional data fields to each personnel data record.

In another embodiment of the present invention, the dynamic database method is implemented in the context of a logistics support database. A logistics support database tracks information associated with individual pieces of equipment. Over time, there may be a need to add data fields to the record for tracking a particular piece of equipment, such as to record information concerning new maintenance procedures, new suppliers or new users. Alternatively, if a particular item is no longer manufactured, it may be appropriate to delete data fields associated with sources of supply.

In another embodiment of the present invention, the dynamic data columns database method is applied to airline schedules. Airline schedule databases record such information as flight number, departure city, departure time, arrival city, arrival time, fare information, special restrictions, and other information. Airlines frequently change fare structures, add new restrictions or customer opportunities, and make other business changes that may require adding or deleting fields in the data records. The methods of the present invention would permit airlines to make such changes to the database without requiring expensive software modifications.

In another embodiment of the present invention, the dynamic data columns database method is applied to a reservation system as might be used in a hotel or similar facility. Since such facilities may add services or capabilities, or offer activities that are seasonally dependent, there is likely to be a need to frequently add data fields to the reservation system or delete fields as services or facilities are no longer available. The dynamic data columns method would permit such changes without having to over-design the database application and data storage system, and without having to invest in frequent modifications to the application software.

In another embodiment, the dynamic database columns method may be implemented on a standalone computer to provide a flexible relational database application suitable for situations where the number of fields of data cannot be anticipated in advance. In such an application, the data would be structured as described herein, but the need for Internet servers would be replaced by the computer's own CPU running software that would cause it to produce user access screens and access and edit data according to the methods described and claimed herein. Such a standalone dynamic database system could be useful in military or disaster response applications where the need for the database and the number of data fields required is difficult to predict in advance and is likely to change overtime.

While the embodiments described herein relate to implementations using the Internet for accessing the database via a web server, it will be appreciated by those knowledgeable in the technology that the present invention applies equally to implementations on intranet, local-area and “hard-wired” networks.

While the present invention has been described in conjunction with the enumerated embodiments, it is evident that numerous alternatives, modifications, variations, applications and uses will be apparent to those skilled in the art in light of the foregoing description. Accordingly, the true scope of the present invention is not limited to any one of the foregoing exemplary embodiments but is instead defined by the following claims.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A computer-readable medium having stored thereon a computer-readable program code comprising a sequence of instructions which, when executed by a computer, cause the computer to perform steps comprising:
receiving from a user computer a query to display a data record within a set of data records having a name, said query comprising a primary key uniquely associated with the data record;
using the name of the set of data records to retrieve a table identifier key from a data table of table identifier keys associated with one or more sets of data records;
using the primary key to access from a data record table a row identifier key;
using the table identifier key to access one or more field identifier keys for the set of data records from a table of data field attributes information;
sending to the user computer the data field attributes information for each data field identifier key; and
sending to the user computer the content of each data field uniquely associated with each data field identifier key and the row identifier key.

2. The computer readable program medium according to claim 1, wherein the computer-readable program code further cause the computer to perform the step comprising:
sending to the user computer the content of a separate data field associated with the row identifier key if a data field identifier key indicates a separate data field is associated with the row identifier key.

3. A computer system, comprising:
a central processor;
an Internet access port connected to the central processor and to a network; and
a data storage system connected to the central processor, the data storage system having stored thereon a sequence of instructions executable by the central processor which, when executed by the central processor, causes the central processor to perform the following steps:
receiving from a user computer a query to display a data record within the set of data records, said query comprising a primary key uniquely associated with the data record;
using the name of the set of data records to retrieve a table identifier key from a data table of table identifier keys associated with sets of data records;
using the primary key to access from a data record table a row identifier key;
using the table identifier key to access field identifier keys for the set of data records from a table of data field attributes information;
sending to the user computer the data field attributes information for each data field identifier key; and
sending to the user computer the content of each data field uniquely associated with each data field identifier key and the row identifier key.

4. A method for enabling a user to access data within a set of data records having a name stored within a relational database comprising sets of data records to permit easy reconfiguration of database tables, comprising:
receiving from a user computer a query to display a data record within the set of data records, said query comprising a primary key uniquely associated with the data record;
using the name of the set of data records to retrieve a table identifier key from a data table of table identifier keys associated with the sets of data records;
using the primary key to access from a data record table a row identifier key;
using the table identifier key to access field identifier keys for the set of data records from a table of data field attributes information;
sending to the user computer the data field attributes information for each data field identifier key; and
sending to the user computer the content of each data field uniquely associated with each data field identifier key and the row identifier key.

5. The method according to claim 4, wherein the user computer sends the query using a web-browser.

6. The method according to claim 4, wherein the query is received via the Internet.

7. The method according to claim 4, wherein the table identifier key is stored on a database editing web page in hidden fields within a selection hyperlink.

8. The method according to claim 4, further comprising the steps of:
processing the data field attributes information using a scripting language, and using a result therefrom to format a web-browser based form; and
displaying at least a portion of the data record in the web-browser based form.

9. The method according to claim 8, wherein the scripting language is one of the following: Java Server Pages script, Visual Basic script or Oracle web cartridges.

10. The method according to claim 4, further comprising the step of sending to the user computer the content of a separate data field associated with the row identifier key if a data field identifier key indicates a separate data field is associated with the row identifier key.

11. A method for programming computer-implemented method for storing in a relational database a set of data records having a name, comprising the steps:
creating a data key data table comprising a primary key and a row identifier key for uniquely identifying a data record for the primary key and row identifier key;
creating a column support data table comprising a table identifier key and the name of the set of data records;
creating a custom fields data table comprising the table identifier key, a field identifier key, and data field attributes information for non-key data each related to a row identifier key; and
creating a custom value data table comprising the field identifier key, the row identifier key, and stored data uniquely related to the field identifier key and the row identifier key.

12. A computer-implemented method for enabling a user to add a column to a data table having a table identifier key, comprising the steps:
receiving from a user computer the table identifier key and a request to create a column in the data table identified by the table identifier key;
using the table identifier key to retrieve a list of columns and a list of attributes from a custom fields data table associated with the table identifier key, said custom fields data table comprising the table identifier key, a field identifier key, and data field attributes information for non-key data each related to a row identifier key;
sending to the user computer the list of columns and the list of attributes information in the data table;
receiving from the user computer data field attributes information for the column to be added;
receiving from the user computer data field attributes information for the column to be added, and
storing in the custom fields data table the data field attributes information for the column to be added.

13. The method according to claim 12, wherein data are sent the user computer as a web-browser based form.

14. The method according to claim 12, wherein requests and data are received via the Internet.

15. The method according to claim 13, wherein the web-browser based form comprises one of the following: Java Server Pages script, Visual Basic script or Oracle web cartridges.

16. The method according to claim 12, further comprising the step of:
sending to the user computer an acknowledgment that the data field attributes information was stored in the custom fields data table.

17. A computer-implemented method for enabling a user to modify a column of a data table having a custom fields table for storing data field attribute information, wherein said column is identified by a column identifier key, comprising the steps:
receiving from a user computer the column identifier key and a request to modify the column identified by the column identifier key;
using the column identifier key to retrieve data field attributes information from the custom fields table;
sending to the user computer the retrieved data field attributes information;
receiving from the user computer updated data field attributes information; and
storing the updated data field attributes information in the custom fields table.

18. The method according to claim 17, wherein the data field attributes information is sent to the user computer as a web-browser based form.

19. The method according to claim 17, wherein requests and information are received from the user computer via the Internet.

20. The method according to claim 18, wherein the web-browser based form comprises one of the following: Java Server Pages script, Visual Basic script or Oracle web cartridges.

21. The method according to claim 17, further comprising the step of:
returning to the user computer an acknowledgment that the updated data field attributes information was stored the custom fields table.

22. A computer-implemented method for enabling a user to delete a column of a data table having a custom fields table for storing data field attribute information, wherein said column is identified by a column identifier key, comprising the steps:
receiving from a user computer the column identifier key and a request to delete the column identified by the column identifier key; and
using the column identifier key to indicate the associated column as inactive in the custom fields data table.

23. The method according to claim 22, wherein the request and column identifier key are received via the Internet.

24. The method according to claim 22, further comprising the step of:
sending to the user computer an acknowledgment that the column has been deleted.
